(19) United States
(12) Patent Application Publication
(10) Pub. No.: US 2023/0115440 A1
(43) Pub. Date: Apr. 13, 2023

(54) Point of Interest System and Method for AR, VR, MR, and XR Connected Spaces

(71) Applicant: Magnopus, LLC, Los Angeles, CA (US)

(72) Inventors: Kevin Mullican, Los Angeles, CA (US); Tyler Ohlsen, Los Angeles, CA (US); Jerome Meyers, Los Angeles, CA (US)

(73) Assignee: Magnopus, LLC, Los Angeles, CA (US)

(21) Appl. No.: 17/954,527

(22) Filed: Sep. 28, 2022

Related U.S. Application Data
(60) Provisional application No. 63/250,126, filed on Sep. 29, 2021.

(51) Int. Cl. G06F 16/29; G06T 19/00; H04L 67/52; A63F 13/537

(52) U.S. Cl. CPC G06F 16/29; A63F 13/537; G06T 19/00; H04L 67/52; G06T 2219/024

(57) ABSTRACT

The present disclosure relates to augmented reality, virtual reality, and mixed reality systems and more specifically, to systems and methods for providing temporal and spatial context to data sources, or entities, for consumable and renderable elements in both virtual and physical worlds.

### CROSS-REFERENCE TO RELATED APPLICATIONS

This application claims priority under 35 USC Section 119(e) to co-pending U.S. Provisional Pat. Application No. 63/250,126 entitled “Point of Interest System and Method for AR, VR, MR, and XR Connected Spaces” filed Sep. 29, 2021; co-pending U.S. Provisional Pat. Application No. 63/250,145 entitled “Platform Agnostic Autoscaling Multiplayer Inter and Intra Server Communication Manager System and Method for AR, VR, Mixed Reality, and XR Connected Spaces” filed Sep. 29, 2021; co-pending U.S. Provisional Pat. Application No. 63/250,152 entitled “Visual Anchor Based User Coordinate Space Recovery System” filed Sep. 29, 2021; and co-pending U.S. Provisional Pat. Application No. 63/250,159 entitled “Bi-directional Cross-Platform Library for Automated Reflection” filed Sep. 29, 2021; all of the entire disclosures of which are incorporated herein by reference.

### FIELD OF THE INVENTION

The present disclosure relates to augmented reality, virtual reality, mixed reality, and extended reality systems, and more specifically, to systems and methods connecting virtual and physical worlds.

### BACKGROUND OF THE INVENTION

Current systems exist that make use of technologies including augmented reality (“AR”), virtual reality (“VR”), mixed reality (“MR”), which are collectively known as extended reality (“XR”), artificial intelligence (“AI”), and the fifth-generation technology standard (“5G”) for broadband cellular networks.

In this context, physical reality often refers to a physical place where a person has to be there to see it, and everyone present sees essentially the same thing. MR and AR are similar in that a person is in the physical place, but they differ from physical reality in that the person can see digital content mixed with the physical objects. People present in MR or AR environments can participate in shared experiences, or the content can be unique to an individual and their interests.

In contrast, VR refers to an environment where a person is remote from the physical place but feels like they are in the physical space. The person can see digital content mixed with digital copies of physical objects. The person may also be able to see shared experiences with other people and/or see content unique to the individual. XR encompasses AR, VR, MR, and those things in between or combinations thereof.

Work in this area includes work on what has been termed the metaverse. While metaverse has multiple meanings, the term is often used more in relation to a fictional, imaginary, and/or virtual world, rather than to a physical world.

Prior work also relates to what has been termed a mirror world. The term mirror world often is used to mean a “digital twin” of the physical world so that a user can access everything in the physical world, such as when playing a 3D video game.

Prior work also includes work on what has been termed the AR Cloud. The AR Cloud concept is about a coordinate system and content delivery.

Initial work has begun on Web XR, which is a standard that will use web technologies to make immersive content available to VR, AR, and 2D devices through a web browser. It is desirable to have a system for creating a connected space that can be compatible with a Web XR standard. Connected spaces enable a shared, coherent experience in this bridged world between users.

Global Information Systems (“GIS”) in a way relate data to a spatial context because the data is collected from and related to a particular place on the Earth’s coordinate system. A satellite or other monitoring device may collect data points over time that are related to the desired metric, and that data can be displayed relative to other location-based data points to draw conclusions or run simulations about a particular geographic region. GIS systems tend to represent data that is frozen in time or is associated with a single point in time, and thus data stored in GIS systems is direct and is not relational.

While a GIS relates data to a spatial context at a certain time, it does not allow for authoring of data across ranges of coordinates or schedules. A GIS defines items on a map that are directly consumed, instead of creating referentially consumed content. A GIS would only be able to show what was physically present in a particular geographic location.

The creation of digital twins, or virtual replicas of physical, digital, or imaginary spaces, at a large scale has remained impossible because of an inability to author and relate random, unstructured data sources to any given coordinate space and schedule. Moreover, in any replicas created with the intention of running simulations and gathering data, accuracy of position between the spaces becomes crucial. While creating these twins, it is important to consider that entities may not exist constantly throughout time. Today’s sunset, for instance, should not be seen midday and should not look exactly like yesterday’s sunset. Fireworks shows should be reserved for holidays and should vary wildly across years and locations. Creators currently lack a system needed to convincingly author these worlds by allowing arbitrary pieces of data or actions to be associated with a coordinate point on a certain schedule.

While this problem is easiest to imagine in the context of a physical space being converted to a virtual one, the same problems still exist in creating relationships between any combination of physical, virtual, and imaginary worlds. Regardless of the nature of these coordinate spaces, it is difficult to relate and author within one coordinate space in reference to another. For example, it would be difficult to recreate the setting of an imaginary board game campaign (despite a very clear coordinate space) in the real world, at scale, without a way to create and relate points in both spaces. By the same token, creating a 3D virtual experience that enables a user to walk through a computer’s filing system like a library would have no way of relating or authoring the hierarchy of files in the computer’s storage to the 3D library representation.

Therefore, it is desirable to create a system and method for use across mixed reality, desktop, web, and mobile platforms for connecting digital and physical spaces that overcomes these limitations.

It is also desirable to have a point of interest (“POI”) system and method for AR, VR, and mixed reality connected spaces.

### BRIEF SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

A connected space (“connected space”) is any combination and/or augmentation of one or more physical worlds and/or digital worlds, to allow one or more individuals to participate in the resulting spatial experience. Whether physically co-located or geographically dispersed, the connected space can be singularly, continually, or periodically consumed by one or more users at the same time, during overlapping times, or at different times, either synchronously or asynchronously.

This invention and disclosure provide a digitization of the places and objects in the physical world that will connect the physical and digital worlds and make connected spaces accessible anywhere in real time.

This invention and disclosure can be used for a connected space that makes the same content as in the physical world accessible through augmented reality (“AR”) devices by turning off the digital twin environment. The physical site can be augmented with smart layers where the matching digital content layers align with the physical world.

This invention and disclosure can be used with a “digital twin” to AR Cloud content to allow the AR Cloud content to become accessible remotely in a connected space.

A system and method are disclosed to create a connected space that is accessible collaboratively from personal computers, mobile phones, or immersive devices.

A POI tool and method is disclosed that does not require content derived from any given physical location, but can support any type of content, independent of the location in which it is to be associated. The only requirement is that the content have context within the location that can be understood by the consumer.

A POI system and method is disclosed that has the ability to establish and maintain the relationship between data and a particular location, or point, in a manner that is flexible and mutable enough to allow for authoring of complex spaces across time schedules.

This invention is particularly applicable, but not limited to, the creation of digital twins. In designing virtual spaces that can conservatively span many square kilometers, multiple users could be working together to author points within a virtual space that contains re-creations of actual items in the physical world. Beyond simply recreating a landscape, the authors could also capture momentary events that may change over time. Using this POI system and method disclosed herein, digital entities ranging from colossal monuments, to raucous parades, to seemingly insignificant benches or power outlets can be related to a coordinate on a physical site and precisely placed within a virtual map at the proper time. Once rendered, the digital content can then be consumed by any number of virtual, augmented, or mixed reality users as if they were actually present.

Connected spaces combined with the physical world provide advantages in a number of applications, such as for design and planning teams, operations, and visitors.

Design and planning teams can collaborate in the physical space that is to be augmented with digital content using the assets they have already created for a better representation of the finished experience. They can share work between different teams in real time, so the teams stay synchronized. They can review and approve work in context with stakeholders also in real time, so there are no surprises.

Before a new operation goes live, simulations can be run to identify operational issues and confirm readiness. If there are data or devices in the environment, it is possible to monitor them in context for faster and better understanding. If live users are trackable through devices or cameras, meaningful analytics can be visualized to help deliver the best experience. The POI system also allows pushing content in context to people’s mobile devices relevant to events happening around them.

Connected spaces combined with the physical world also give visitors a better experience and access to richer content, in context, through mobile phones and other devices.

Connected spaces combined with users of mobile AR and mixed reality provide advantages in a number of applications, such as for design and planning teams, operations, and visitors.

Design and planning teams can virtually preview the space while it is in progress and see what is coming. They can create narrative journeys, such as tour guides, to meet visitors’ interests. They can review digital content in context. They can review and approve work in context with stakeholders.

Before a new operation goes live, the team can get an “Iron Man”, or mission control, view of the relevant systems and data in the context of the space. The POI system also allows the team to maintain situational awareness for live operations.

Connected spaces combined with users of mobile AR and mixed reality also give visitors access to interactive digital content in context to the physical content personalized to the specific visitors. The POI system in concert with the Visual Positioning system allows visitors to know where they are and where they want to go with better wayfinding. The POI system and the Visual Positioning system also allow visitors to keep track of friends and family who want to share their locations.

Connected spaces combined with users of VR or remote users on desktop or mobile devices provide advantages in a number of applications, such as for design and planning teams, operations, and visitors, particularly when access to the physical space is prohibitive or impractical. Using connected spaces, design and planning teams can access all the features of mixed reality and regular reality but with additional benefits and options. The lack of constraints from the laws of physics that define purely digital activations unleashes an additional degree of creative freedom and simulation that is not tied to the limitations of a physical environment.

Before a new operation goes live, it is possible to publish and monetize a space to access a remote audience. Connected spaces combined with users of VR or remote users on desktop or mobile devices allow for more space, virtually, for content than the actual physical site offers. Spaces can also be archived so they can live on after the physical space is gone. The team can also manage the live space, see the users, and ensure they are receiving the best experience.

Visitors can access the places and people they want to visit from across the world. The POI system enables remote workforces, reduces travel and conference costs, and provides a unified experience across the physical and digital content.

Connected spaces have the advantage of bringing people around the world together. On-site and off-site users can see each other and share a common experience across all consumer devices.

Accordingly, one or more embodiments of the present invention overcomes one or more of the shortcomings of the known prior art.

For example, in one embodiment, a points-of-interest system for a connected space is disclosed comprising: a controller; a plurality of objects, each of the plurality of objects comprising a coordinate; wherein the controller creates a record mapping the coordinate of each of the plurality of objects to an object reference identifier for the object; an object database for storing the object reference identifier for each of the plurality of objects; a cloud storage; and wherein the object database provides at least one object reference identifier to the cloud storage.

In this embodiment, the system can further comprise a position determining component for correlating a physical location of a first device with a digital location; a digital location database; wherein the digital location database looks up digital content for a physical location in the object database; wherein the object database returns the digital content for the physical location to the first device; wherein the digital location database looks up digital content for the digital location of a second device in the object database; and wherein the object database returns the digital content for the digital location to the second device.

In this embodiment, the system can further comprise wherein: the positioning determining component is a global positioning system (GPS) or a compass; the first device is a smartphone or a tablet; the second device is a smartphone or a tablet; the plurality of objects comprises at least one physical object; the plurality of objects comprises at least one virtual object; the plurality of objects comprises at least one physical object and at least one virtual object; the object database stores metadata for each of the plurality of objects; the points-of-interest system is cloud hosted.

In another example embodiment a points-of-interest system for a connected space is disclosed comprising an authoring interface for creating and editing a plurality of points of interest within a coordinate space and a time by associating data with a set of coordinates and a time schedule; and a service interface for logging and maintaining the relationships for the plurality of points of interest.

In this embodiment, the system can further comprise wherein: the coordinate space is a physical coordinate space; the coordinate space is a virtual coordinate space; the coordinate space is a combined physical coordinate space and virtual coordinate space.

In another example embodiment a method for creating and accessing points of interest in a connected space is disclosed comprising: storing an object reference identifier for each of a plurality of objects in an object database; receiving coordinates for an object; mapping the coordinates for the object to an object reference identifier for the object; storing a record with the mapping of the coordinates for the object to the object reference identifier for the object in the object database.

In this embodiment, the system can further comprise: providing a cloud storage; receiving at least one locally referenced object at the cloud storage; assigning the at least one locally referenced object an object reference identifier; providing at least one object reference identifier for the at least one locally referenced object from the cloud storage to the object database.

In this embodiment, the system can further comprise: receiving at least one object reference identifier for at least one remotely stored object from a remote cloud storage.

In this embodiment, the system can further comprise: creating a connection between a physical object and a virtual object using a web-hosted, two-dimensional map interface.

In this embodiment, the system can further comprise: creating the connection between the physical object and the virtual object using an immersive virtual reality interface.

In another example embodiment a method for accessing points of interest in a connected space is disclosed comprising: receiving a physical location for a physical site in a physical coordinate space from a first device with a first camera at the physical location in the physical site in the physical coordinate space; receiving a digital location in a coordinate space for a digital twin of the physical site from a second device; providing a position determining component for correlating the physical location with the digital location; providing a digital location database; providing an object database with an object reference identifier for each of a plurality of objects associated with the physical site and for each of a plurality of objects associated the digital twin of the physical site; correlating the physical location of the first device with the digital location using the position determining component; looking up a digital content for the physical location in the object database; returning the digital content at the physical location to the first device; looking up digital content at the digital location of the second device in the object database; and returning the digital content at the digital location to the second device.

In another example embodiment, a platform for a connected space is disclosed comprising: a point-of-interest system; a massively multiplayer online (MMO) system; a visual positioning system; and a foundation.

In another example embodiment, a points-of-interest system for a connected space comprising: a plurality of objects, each of the plurality of objects comprising: a coordinate; and a temporal information component, wherein the temporal information component indicates when the object is active; a controller wherein the controller maps the coordinate of each of the plurality of objects to an object reference identifier; an object database for storing the plurality of objects and the plurality of object reference identifiers; and a cloud storage for providing at least one object reference identifier to the object database.

In this embodiment, the system can further comprise: a position determining component for correlating a physical location of a first device with a digital location; a digital location database; wherein the digital location database looks up digital content for a physical location in the object database; wherein the object database returns the digital content for the physical location to the first device; wherein the digital location database looks up digital content for the digital location of a second device in the object database; and wherein the object database returns the digital content for the digital location to the second device.

In this embodiment, the system can further comprise wherein: the positioning determining component is a global positioning system (GPS) or a compass; the first device is a smartphone or a tablet; the second device is a smartphone or a tablet; the plurality of objects comprises at least one physical object; the plurality of objects comprises at least one virtual object; the plurality of objects comprises at least one physical object and at least one virtual object; the object database stores metadata for each of the plurality of objects; the points-of-interest system is cloud hosted; the plurality of objects comprises at least one physical object; the plurality of objects comprises at least one virtual object; the plurality of objects comprises: at least one physical object; and at least one virtual object; the object database stores metadata for each of the plurality of objects; the points-of-interest system is cloud hosted.

In another example embodiment, a method for creating and accessing points of interest in a connected space is disclosed comprising: storing an object reference identifier for each of a plurality of objects in an object database wherein the object reference identifier comprises a temporal information component indicating when the object is active; receiving coordinates for an object; mapping the coordinates for the object to an object reference identifier for the object; storing a record with the mapping of the coordinates for the object to the object reference identifier for the object in the object database.

In this embodiment, the method can further comprise: providing a cloud storage; receiving at least one locally referenced object at the cloud storage; assigning the at least one locally referenced object an object reference identifier; providing at least one object reference identifier for the at least one locally referenced object from the cloud storage to the object database.

In this embodiment, the method can further comprise: receiving at least one object reference identifier for at least one remotely stored object from a remote cloud storage; or creating a connection between a physical object and a virtual object using a web-hosted, two-dimensional map interface; or creating the connection between the physical object and the virtual object using an immersive virtual reality interface.

In another example embodiment, a platform for a connected space is disclosed comprising: a point-of-interest system comprising: a plurality of objects wherein each of the plurality of objects comprises a temporal information component; and wherein the point-of-interest system uses the temporal information component for each of the plurality of objects to determine when the objects are active; a massively multiplayer online (MMO) system; a visual positioning system; and a foundation.

In another example embodiment, a points-of-interest system for a connected space is disclosed comprising: an object comprising: a coordinate; and a temporal information component, wherein the temporal information component indicates when the object is active; a controller wherein the controller creates a record mapping the coordinate of the object to an object reference identifier for the object; an object database for storing an object and the object reference identifier for the object; a cloud storage; and wherein the object database provides at least one object reference identifier to the cloud storage.

In this embodiment, the system can further comprise: a position determining component for correlating a physical location of a first device with a digital location; a digital location database; wherein the digital location database looks up digital content for a physical location in the object database; wherein the object database returns the digital content for the physical location to the first device; wherein the digital location database looks up digital content for the digital location of a second device in the object database; and wherein the object database returns the digital content for the digital location to the second device.

In this embodiment, the system can further comprise wherein the positioning determining component is a global positioning system (GPS); wherein the positioning determining component is a compass; wherein the first device is a smarthone; wherein the first device is a tablet.; wherein the second device is a smartphone; wherein the second device is a tablet; wherein the object is a physical object; wherein the object is a virtual object; wherein the object database stores metadata for object; or wherein the points-of-interest system is cloud hosted.

Other objects, features, and advantages of the present invention will become apparent upon consideration of the following detailed description and the accompanying drawings.

### BRIEF DESCRIPTION OF THE DRAWINGS

FIG. 1 illustrates a platform for coherently managing real-time user interactions between the virtual and physical items, character bots, and other human participants, whether in VR, AR, MR, or XR.

FIG. 2 shows an example embodiment of the POI system and correlated physical and digital content.

FIG. 3 illustrates an example system architecture for the Platform.

FIG. 4 shows an example embodiment of a block diagram for a POI authoring implementation

FIG. 5 shows an example embodiment of a POI authoring workflow.

FIG. 6 shows an example embodiment of a coordinate system.

### DETAILED DESCRIPTION OF THE INVENTION

The following is a detailed description of embodiments to illustrate the principles of the invention. The embodiments are provided to illustrate aspects of the invention, but the invention is not limited to any embodiment. The scope of the invention encompasses numerous alternatives, modifications, and equivalents. The scope of the invention is limited only by the claims.

While numerous specific details are set forth in the following description to provide a thorough understanding of the invention, the invention may be practiced according to the claims without some or all of these specific details.

Various embodiments will be described in detail with reference to the accompanying drawings. Wherever possible, the same reference numbers are used throughout the drawings to refer to the same or like parts. References made to particular examples and implementations are for illustrative purposes and are not intended to limit the scope of the claims.

The disclosed invention is used to create a connected space, which is a common space that bridges the physical world and a digital, or virtual, copy that exists at the same time. Connected spaces can be accessible collaboratively from personal computers, mobile phones, immersive devices, or other similar devices.

### Platform 100 Overview

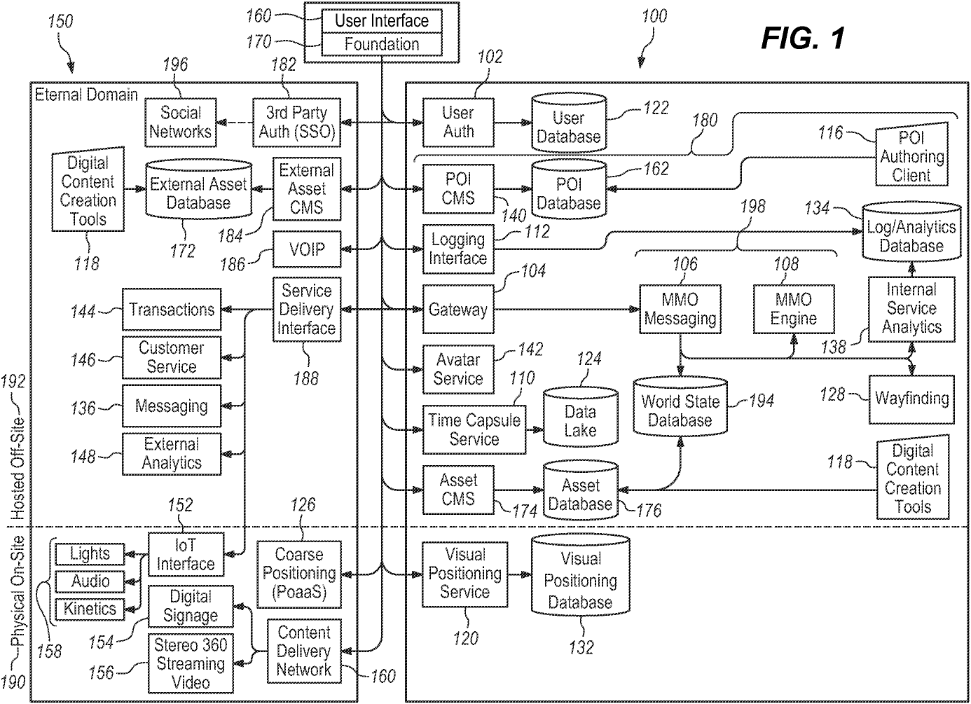

As shown in FIG. 1, Platform 100 according to the present invention is a technology platform that allows users to design, build, and operate a connected space that bridges physical and digital spaces. It powers XR experiences to be accessed by users anywhere in the world at any time. It allows multiple users to collaborate in the design and review process, such as when designing a real-world location of interest and simulated mission. Platform 100 can import a “digital twin” anchored in a real-world location with geo-contextualized data.

Platform 100 comprises a user authentication service 102, gateway 104, MMO messaging 106, MMO engine 108, time capsule service 110, logging interface 112, Point-Of-Interest (POI) system 180, avatar service 142, and Visual Position Service (VPS) 120. The Magnopus World Services Platform is an example of Platform 100. MMO services 198 comprises MMO engine 108 and MMO messaging 106. Internal analytics can be done by internal service analytics 138 using log analytics database 134.

In one example embodiment, Platform 100 allows visualization of assets and mission components as trainers design operational challenges for trainees. Platform 100 can publish and make available to operate the connected space, enabling end users to conduct activities (e.g., whether consumers engaging with experiences or enterprise users with operational activities) within Platform 100. It also can gather data from trainee performance in missions and easily adjust elements within the missions to create additional operational scenarios.

External services 150 are either located at physical on-site 190, which is the physical site of the visitors, or located at hosted offsite 192, such as a cloud environment. IoT infrastructure 158, coarse positioning 126, and digital signage 154 and audio/video streaming 156 are located at the physical on-site 190. In one embodiment, third party authentication service 182, external asset CMS 184, VOIP 186, and service delivery interface 188 are located at hosted offsite 192. In one embodiment, third party authentication service 182 is used to authenticate social networks 196. In another embodiment, service delivery interface 188 can be used for interaction with external services 150 such as transactions 144, messaging 136, customer service 146, and/or external analytics 148.

In one embodiment, external services 150 can be a smart environment that responds to visitors through user interface 160, which in various embodiments can comprise an AR and/or VR interface, mobile apps, web applications, desk and other devices that respond to visitors.

The AR and social capabilities can connect to the IoT infrastructure 158 via IoT Interface 152 of external services 150. In one example, this is built on a 5G infrastructure. In one example, humans, avatars, and AI characters can interact. The people, characters, and even objects can interact. Interaction is non-linear, mirroring the real world. For remote visitors, PC or mobile applications, including VR, grant access to the connected space where the remote visitors can connect with the physical content and on-site visitors. VOIP 186 and content delivery network 160 can connect visitors in the physical world with those attending virtually via digital signage 154 and audio/video streaming 156.

Platform 100 provides cross-device flexibility, allowing access to the same connected space across multiple devices, including VR, desktop, mobile (2D and AR), and web. All updates to the core connected space are automatically updated for all devices.

Platform allows real-time social and multiplayer interaction. Users can interact intuitively with other users with highly-naturalistic social mechanics.

Platform 100 implements the functionality necessary to create a digital twin of a physical location. Platform 100 populates the location with digital elements including architectural geometry, virtual items, and automated characters via world state database 194 and avatar service 142. Platform 100 coherently manages real-time user interactions between the virtual and physical items, character bots, and other human participants, whether in VR, AR, MR, or XR.

The user authentication service (UAS) 102, user data base 122, and third party authentication service 182 provides support for multi-tiered access to the services for a connected space and abstracts and extends the functionality of any underlying, full-featured User Access Management (UAM) system. In addition to full user authentication and authorization, UAS 102 also allows anonymous and stateful, non-personally identifiable information (PII) user access from user database 122. UAS 102 is responsible for granting tokens and managing access to the appropriate backend services for each tier of user. UAS 102 is able to automatically migrate user accounts from anonymous and non-PII accounts to full UAM accounts without additional user intervention.

Gateway 104 enables a transparent connection between user application requests and the appropriate backend services. Gateway 104 is responsible for automatically provisioning and deploying new services, scaling existing services, and removing unused services based on user demand. Through, for example, a uniform RESTful API, Gateway 104 implements reverse proxy, port redirection, load balancing, and elastic scaling functions. Gateway 104 provides a simple, deterministic interface for user access and resource management, masking the underlying complexity of the service architecture.

Massive multiplayer online (MMO) Messaging 106 is the robust data routing and communication layer for the broader set of services that are a collection of loosely coupled microservices. The microservice architecture provides several key advantages over a monolithic solution including ease of maintenance, extensibility, continuous deployability, abstraction of complexity, and scalability. However, in order to gain the advantages of a microservice solution, the MMO Messaging 106 implements a standalone, scalable message passing interface with a strictly defined, but abstract and simple, protocol for defining message sources, destinations, types, and payloads. MMO Messaging 106 can rapidly inspect message metadata and ensure all messages are delivered to the intended recipients. MMO Messaging 106 is the nervous system of Platform 100.

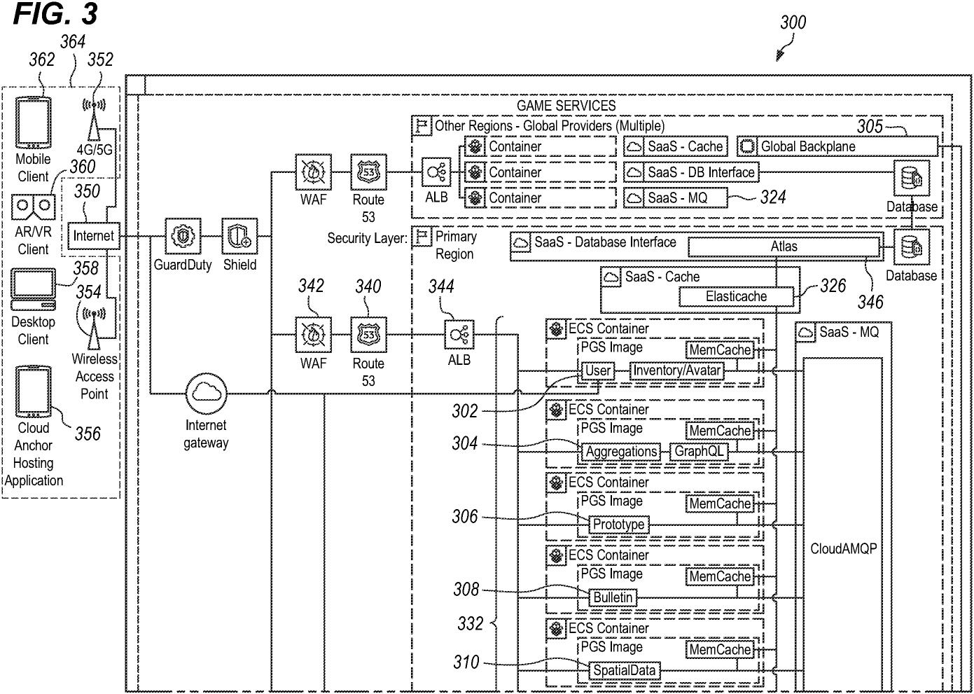

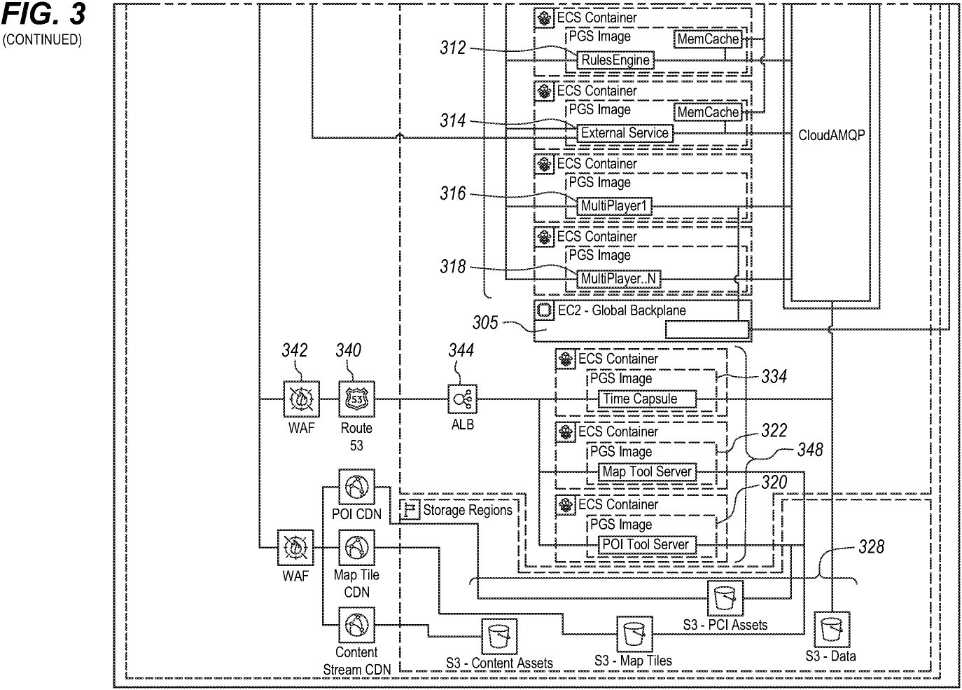

MMO Engine 108 is a collection of loosely coupled microservices 332 (FIG. 3) that enable a massive persistent, shared world space for arbitrary numbers of simultaneous and asynchronous users. MMO engine 108 utilizes multiplayer technology that governs seamless interactions between users. MMO engine 108 enables scaling up of users within Platform 100 and driving multiplayer interactions.

MMO engine 108 is extensible in order to support future requirements. MMO engine 108 comprises several core components including in one example embodiment as shown in FIG. 3 object prototype services 306, user management services 302, multiplayer services 316 and/or 318, and spatial data services 310. User management services 302 implements support for stateful user information such as inventory and history. Object prototype services 206 provides abstract, non-user object prototype and world object instantiation functionality. Multiplayer services 316 and/or 318 maintains the real-time state of users and objects by geographic region, and broadcasts location and state changes to all other users and objects in the region.

Through the collection of microservices 332, though users may enter and exit the world at will, the overall state of the world remains synchronous and persistent. In addition, client applications are able to request classes of world elements relevant to their function. For example, virtual reality applications would request all geometry in the world, but augmented reality applications would only need user and transient object geometry. MMO Engine 108 provides the core components for maintaining a common, interactive world to all users.

Time Capsules are a unique method of allowing participants to take away a tangible memento of their time in a connected space that is experienced in VR, AR, MR, or XR. Time Capsules are graphical timelines of the users’ journeys through the connected space, complete with personal pictures and text of the experience. Time Capsule Service 110 facilitates this by capturing, contextualizing, and storing the artifacts of an attendee’s journey in data lake 124. Once the user leaves the connected space, the service generates a visual summary and presents it to the user so that they can continue to access and relive their journey.

Platform 100 further comprises POI (Point of Interest) authoring client 116 and digital content creation tools 118. The digital world is only engaging if it is populated with content. The world content is divided into two primary classes: Points of Interest and World Data. The system includes POI authoring client 116 and digital content creation tools 118 for creating each class of content.

In an example embodiment, the world space is stocked with real world points of interest, from artwork to architecturally significant structures, and from historically significant artifacts to culturally significant elements. POI (Point of Interest) Authoring Client 116 provides the interface to define these elements and their associated metadata. POI Authoring Client 116 is also a graphical map interface with UX elements for adding, modifying, and deleting points of interest and individual metadata fields. POI Authoring Client 116 manages the definition of relations for existing, network accessible metadata as well as the uploading of content to the POI database 162.

For world items that are not authored in POI authoring client 116 the digital content creation tools 118 provides the interface for defining them. These items include items such as building geometry, landscape components, architectural detail, civil structures, digital signage 157, and site decoration. The digital content creation tools 118 allow authors to associate assets in the asset database 176 and external asset store database 172 with their positions in the digital world space. The client also manages the uploading of digital assets to the asset database 176 and external asset store database 172. The client includes a fully immersive interface for interacting with the total world space, such as in VR.

User interface 160 comprises the user-facing elements of Platform 100, and it is the portal through which users interact with the world and other users. Through various presentation models including VR and AR on multiple devices such as mobile, desktop, and wired and standalone HMDs, users employ natural interactions using familiar interfaces such as 6 Degrees of Freedom (DOF) controllers and thumbsticks. Since user interface 160 is the way general users experience this world, the usability and enjoyability of them is critical. User interface 160 is built on top of foundation 170, and communicating in real time and retrieving the world elements on demand from MMO engine 108 to aid in creating a seamless experience.

Platform 100 is an architecture that can support an extremely large and complex environment. Given that there is a finite capability in the devices running the end user applications, a world with infinite complexity would not be possible to represent. The client applications include renderer functions that work in conjunction with the backend services and visualization capabilities to present a convincing immersive experience for the user with the essential and relevant data and representations for that user.

Foundation 170 abstracts and unifies all the functionality necessary to provide a seamless, networked immersive user experience. It includes a developer interface to build the user experiences and the libraries to deploy the experiences to the user-facing applications. It coordinates the communication between the abstract backend world representation and the in-experience user-facing environment. Foundation 170 is the bridge between the world state and the human computer interface.

To provide a believable and effective augmented reality for users to collaborate within, concrete anchors to the absolute physical world coordinate space are used. Users must be able to see the same things in the same place at the same time, and experience the results of interactions as they occur. The Visual Positioning System 120 abstracts the generalized functionality and in an example embodiment, interfaces with third party systems. In addition, as systems evolve, and new approaches emerge, they can be easily integrated without need to rebuild the abstract interface.

Geo-contextualized data stored in VPS database 132 is incorporated by the Visual Positioning System 120. Content and experiences in connected spaces are mapped to real-world locations with high accuracy, such as centimeter-level accuracy. Visual Positioning System 120 streams in relevant data feeds like IoT devices or other equipment and sensors to create additional contextually relevant experiences within the connected space.

The Point-of-Interest (POI) system 180 comprising POI CMS 140, POI Authoring Client 116, and POI database 162 allows Platform 100 to place content and experiences within a “map” of the digital twin.

As the complexity of the world expands and the number of users grows, the data transfer requirement expands exponentially. An action by a single user or interaction with a world element must be broadcast to all other users within a given proximity in real-time. To accomplish this without overwhelming the abilities of the user devices and available network bandwidth requires sophisticated numerical packing and statistical evaluation of the shared data to ensure that the appropriate transforms are shared, but that non-critical data is reserved, delayed, or discarded. The transit logic and distribution system are part of MMO messaging 106 and MMO engine 108. The transit logic and distribution system comprise the adaptive, intelligent transport system and are critical to the success of the world experience because the assist with data conservation, bandwidth conservation, and other resource conservation.

In an example embodiment, Platform 100 handles dynamic content, allowing the import and export of environments and assets across multiple standard 3D and 2D file types while scenarios are running.

In an example embodiment, Platform 100 provides customizable experiences by defining rules that power events, activities, and exercises that govern a connected space.

In an example embodiment, Platform 100 provides data analytics that track user activities and experiences across the connected space. It gathers aggregate data in a dashboard to analyze user activities.

Foundation 170 provides the capabilities for Platform 100 to be game-engine agnostic. In an example embodiment, Unity and Unreal plugins allow developers to use either engine and still collaborate with users in the other engine. This device-agnostic approach accommodates collaboration across different projects, teams, and partner workflows into the same platform.

In one example embodiment, the system architecture includes a 5G network and Wi-Fi access points to PoP connections via service delivery interface 188 and gateway 104 to hosted off-site services 192; visitor positioning via VPS 120, course positioning 126, and wayfinding 128; mobile to IoT systems integration via IoT interface 152; site-wide integrated display via VOIP 186 and content delivery network 160 comprising digital signage 154 and audio/video streaming 156; digital twin capability via world state database 194 and avatar service 142; external asset CMS 184, external asset database 172, POI CMS 140, POI database 162, asset CMS 174, and asset database 176 for bridging AR and VR users; large scale cross-platform communication via gateway 104 and user interface 160; and MMO engine 108 for visitor experience.

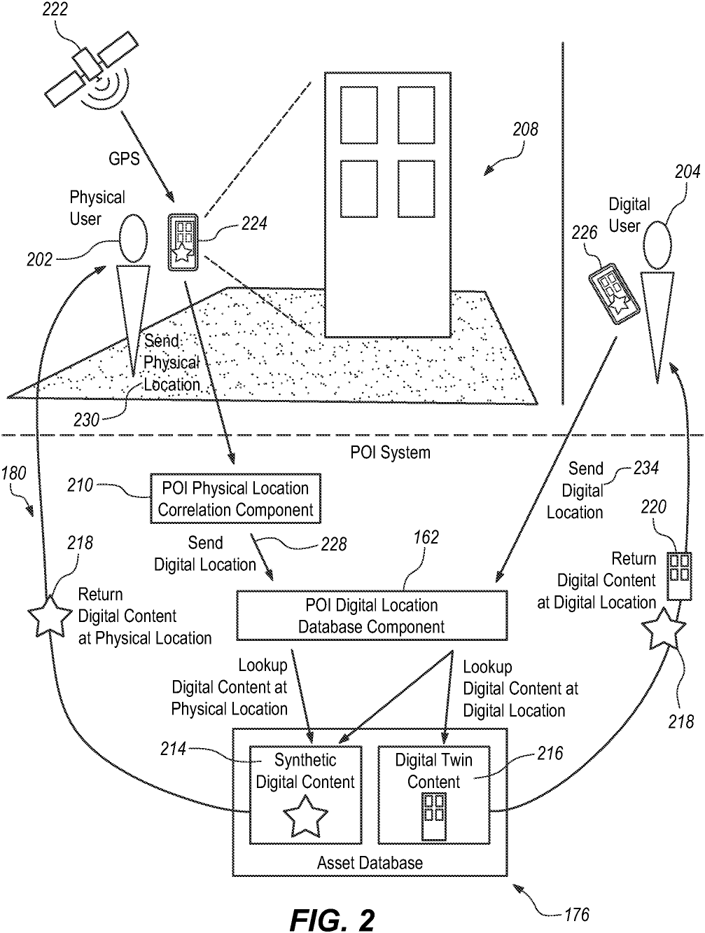

As shown in FIG. 2, the POI system 200 enables both physical participants 202 and digital participants 204 to see and interact with the same digital content in asset database 176. The system forms the bridge between physical locations 208 and correlated digital content in asset database 176. Through their appropriate platforms and interfaces, the POI system 200 looks up the applicable content for the user’s requesting context in synthetic digital content database 214 and/or digital twin content database 216, and participants are presented with the subset of digital content comprising synthetic digital content 218 and/or digital twin content 220, as appropriate for their modalities. Both digital participants 204 and physical participants 202 see synthetic digital content 218. Additionally, digital participants 204 see digital twin content 220 for the physical locations 208.

Digital twin content 216 comprises one-to-one (1:1) digitally modelled representations of real-world items. These are stored in the POI database 162, asset database 176, and visual positioning database 132 with the geographic coordinates of the items and pointers to the digital model data. The physical location of the digital twin content is stored in the POI database 162, with a pointer to the digital model content stored in the asset database 176. The connection between the physical location in the POI database and the digital coordinate space is stored in the visual positioning database 132.

As illustrated in FIG. 2, the models are made available to digital participants 204 when they enter the virtual locations correlated with the physical locations 208.

Synthetic digital content 214, or virtual items, which items that do not exist in the real world, are also stored in the POI database 162, asset database 176, and visual positioning database 132 with the exact desired geographic coordinates and pointers to the digital model data. As illustrated in FIG. 2, synthetic digital content 214 is made available to both digital and physical participants when they enter the correlated locations. Because the system stores items referentially, the underlying models may be updated or changed while retaining their spatial relationships. As well, since synthetic digital content 214 comprises virtual items, synthetic digital content 214 is not static and may be programmatically interactive.

The solution for the physical user 202 starts with physical location resolution. This may be accomplished through various methods such as GPS system 222 and/or compass systems as well as through the Visual Positioning System 120. The physical user’s device 224 shares the derived physical location 230 with POI Physical Location Correlation component 210, shown in FIG. 2, which converts the physical location 230 to correlated digital coordinates 228 in a digital coordinate space. Correlated digital coordinates 228 is an output of POI Physical Location Correlation Component 210. Correlated digital coordinates 228 is an input to POI database 162. Correlated virtual digital models 218 at the requested location are returned to the physical user 202 from asset database 176 for composition into the physical user’s interface.

For digital user 204, their device 226 uses their digital coordinates 234 to look up digital content in asset database 176 in the POI database 162. Like physical user 202, correlated virtual digital models 220 at the requested location are returned to digital user 204. In addition, correlated digital twin content 216 is returned to the digital user’s device 226. The device 226 then composites the synthetic digital content 214 and digital twin content 216 to present digital user 204 with a full virtual representation of the physical space 208.

FIG. 3 illustrates an example system architecture for the cloud hosted services (CHS) system 300. In one embodiment, CHS system 300 is hosted on Amazon Web Services, but in other embodiments, may be adapted to most modern cloud service providers. CHS system 300 comprises multiple, loosely coupled micro-services 332. In one embodiment, these micro-services 332 comprise user management services 302, service aggregations 304, object prototype services 306, notification bulletin 308, spatial data services 310, rules engine 312, external service 314, and multiplayer services 316 and 318. In one embodiment, spatial data service 310 comprises cloud anchors for visual positioning and POI data. Microservices 332 are containerized and scalability is managed through a container service, such as in one example embodiment the AWS Elastic Container Service (“ECS”).

Also hosted within CHS system 300 are management and operational tools 348 comprising a POI tool service 320, user tracking map tool service 322, and time capsule tool service 334. In one embodiment, for efficient internal communication, CHS system 300 relies on SaaS solutions, such as in one embodiment RabbitMQ 324 for non-realtime services and a global Redis cluster 326 for real-time, low latency services. Persistent data is stored in database 328, such as a MongoDB database. Caching is facilitated through Redis cluster 326. Management and operational tools 348 are also containerized and scalability is managed through a container service 330, such as in one example embodiment the AWS ECS.

User-facing data is stored in storage 328 separately from system logic. This allows for more efficient storage and delivery of data through a content delivery network while maintaining the flexibility of a referential, decoupled logic layer. Data can be updated and versioned independently of the referring logic.

Service REST and WebSocket interfaces are available to Internet-connected clients through proxied load balancer 344. Load balancers 344, WAF 342 and resolvers 340 route traffic to microservices 332 and management and operational tools 348 based on a real-time load of the microservices 332 and management and operational tools 348. Messages are forwarded through a global backplane, which is connected to multiplayer services 316 and/or 318

Non-realtime services support stateless REST interfaces for user management services 302, service aggregations 304, object prototype service 306, spatial data service 310, rules engine 312, and external service 314. Real-time, low latency services support stateful WebSocket and SignalR interfaces for notification bulletin 308 and multiplayer services 316 and 318. External clients 364 may include mobile 262, web desktop 358, AR/VR/XR 360, and cloud anchor hosting applications 356. The only requirement for using CHS system 300 is an Internet connection 350, whether through wired 366, wireless 354, or mobile 4G/5G/nG networks 352.

In various embodiments, CHS system 200 services may be deployed in any of a shared tenancy, dedicated, or on-premises model. CHS system 200 services may also be directly connected to external sites and networks, such as in one embodiment through AWS Direct Connect. CHS system 200 services may also optionally be integrated with external SaaS solutions, such as Google Cloud Anchors or Google Firebase.

In an example embodiment, the Visual Positioning System (VPS) 120 leverages spatial data 208, POI CMS 140 and POI database 162. Spatial data service 310 is used to store and make available authored anchors 310. POI CMS 140 and POI database 162 are used to store references to the digital twin models in world state database 194 that are used for alignment when hosting anchors.

The point-of-interest (POI) system 200 and method provides simulation of objects in a combined, or connected, digital and physical space that may or may not actually exist.

Associating entities with coordinate spaces and time windows, especially those that do not exist in the same reality, presents a unique challenge to those attempting to relate data in a spatiotemporal context.

POI system 200 unifies the physical and virtual worlds and defines the relationships between physical and virtual items. POI system 200 comprises POI CMS 140 and POI database 162. For an object, POI database 162 stores the relationship between the object’s coordinate space location and the reference to the object. POI authoring client 116 that enables users to create connections. POI authoring client 116 allows the creation of connections through either a web-hosted, 2D map interface or an immersive VR interface. Points of interest exist at the very nexus between the physical and virtual worlds and are the lowest level connective tissue to bring these worlds together.

POI system 200 makes it possible for a single user, or multiple simultaneous users, to associate generic entities in a referential fashion with a location in a physical, virtual, or imaginary coordinate across space and time. POI system 200 comprises POI authoring client 116 and a POI CMS 140 and POI database 162, hosted and served by spatial data server 310, which encapsulates the logic, storage, and retrieval functions. POI authoring client 116 allows users to author and edit points of interest within a coordinate space by associating data with a coordinate and schedule while the service tracks, logs, and maintains these relationships.

Storing temporal information for objects improves network bandwidth and reduces the required resources because, unlike GIS systems, an object is only displayed when the time is correct. For example, sunset is not displayed midday and should not look exactly the same every day, and fireworks can be reserved for holidays and can vary across years and/or locations.

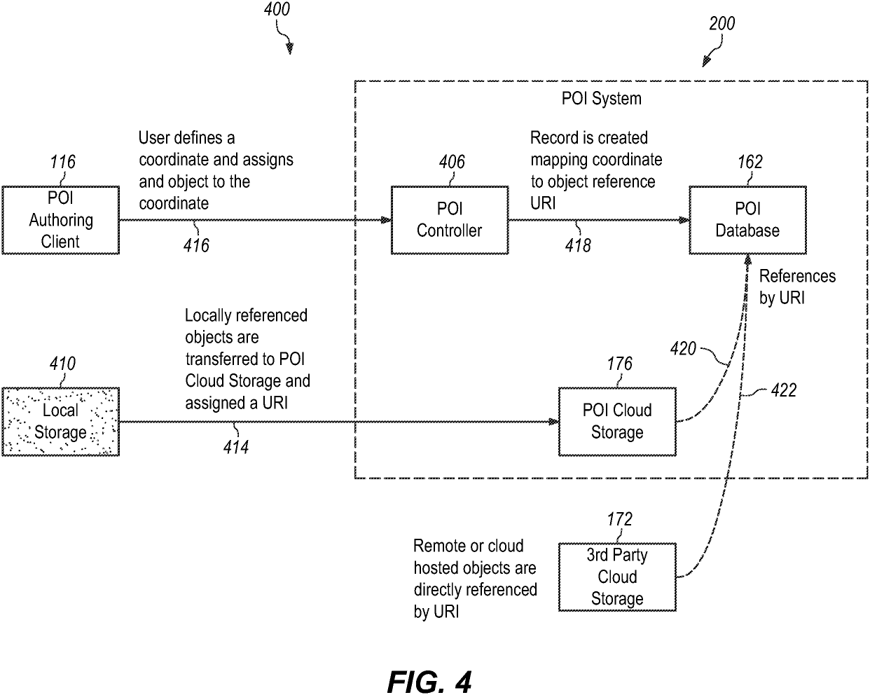

FIG. 4 shows a block diagram for an example embodiment of a POI authoring implementation 400 comprising POI system 200, POI authoring client 116, and local storage 410. POI system 200 gives temporal and spatial context to data sources, or entities, and provides methods to store and serve device independent consumable and renderable elements. POI system 200 functions as the connective sinew between a location block within a space at given periods of time and the data intended to be stored at the particular spatiotemporal coordinate. POI system 200 also facilitates the creation of this connectivity. This is achieved by a structure in two parts.

POI system 200 further comprises POI controller 406, POI database 162, and POI cloud storage 176. POI cloud storage 176 is cloud hosted storage for content made available by POI system 200. POI authoring client 116 is a user interface for interacting with POI system 200 for authoring content locations and time windows. POI authoring client 116 allows users to author and edit data related to a specific coordinate and provide it to POI controller 406 via POI input 416. Control, definition, and association messages that the user executes are provided through POI authoring client 116 via POI input 416 to POI controller 406. POI controller, which the front-facing component of the service receives and interprets the messages.

POI database 162 stores and tracks all of the relationships that are either authored by a user on POI authoring client 116 or fed directly into the POI database 162 via POI cloud data processing stream 420 from POI cloud storage 176 and via third party cloud data processing stream 422 from third party cloud database 412. Cloud data processing stream 420 is the URI referential defined relationship between the POI and the author uploaded content. Third party cloud data processing stream 422 is the URI referential defined relationship between the POI and any externally hosted content. Local storage 410 transfers locally referenced objects to POI cloud storage 176 via local input 414. Local storage 410 is non-cloud storage for data that must be uploaded into the cloud for the POI system to share with clients

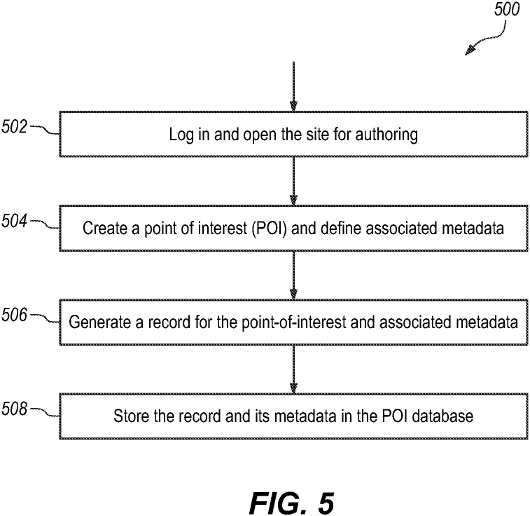

FIG. 5 shows an example embodiment of a POI authoring workflow. As shown in FIG. 5, using POI system 200, at step 502 the user logs in and opens the site they are interested in authoring. At step 504, the user then creates a point of interest (POI) and defines all the associated metadata. The user can either upload an item to be referenced by the newly defined POI location, or coordinate, or can provide an external Uniform Resource Identifier (URI). At step 506, POI controller 406 generates a record that is provided via output 418 to the POI database 162. At step 508, POI database 162 stores the record and its metadata, including the URI to the content or object associated with the POI. This record may be updated or deleted through the POI authoring client 116. This record may also be read by an end-user, application, or other service wishing to retrieve the content or object at the given location.

POI system 200 allows metadata 218 to be consumed in spatial and temporal contexts. Metadata 218 is returned by the spatial data service 310 after the client application shares its physical location 230 and that location is matched to a POI entry in POI database 162. This is shown in FIG. 2.

Consumers are often human users experiencing the space in which the data is being offered, but they can be any entity that understands the coordinate space and time in which the data resides.

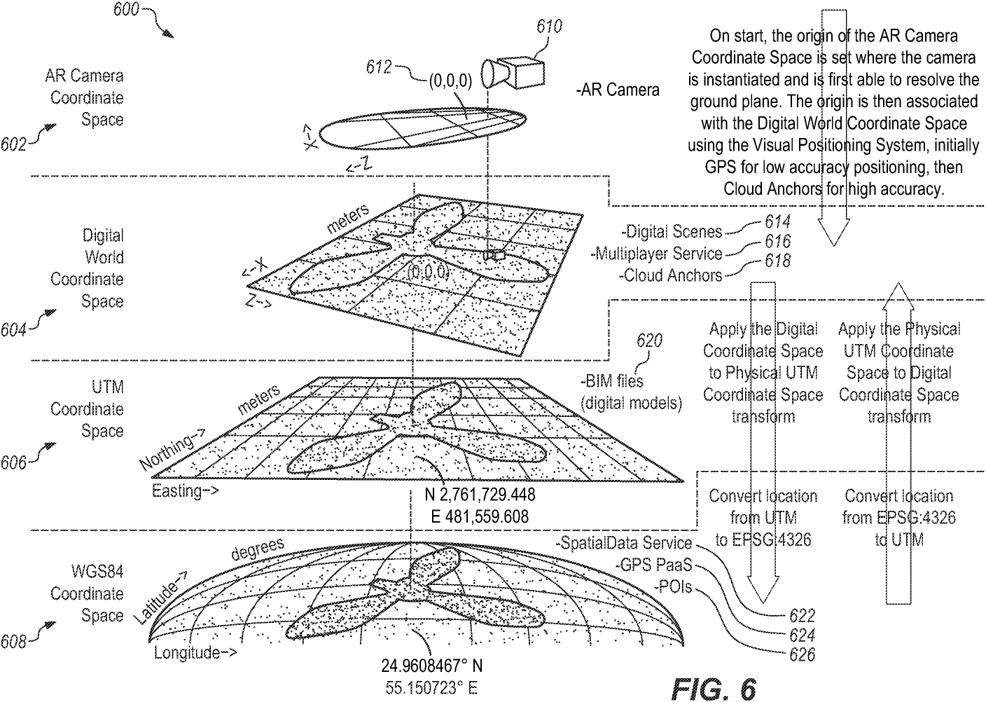

FIG. 6 illustrates an example embodiment of a coordinate space 600. Coordinate space 600 is a parameterized representation of a spatial environment. Coordinate space 600 comprises an AR camera coordinate space 602, a World Coordinate Space 604, a UTM coordinate space 606, and a World Geodetic System 1984 (WGS84) coordinate space 608. An AR camera 610 is in the AR camera coordinate space 602. Scenes 614, multiplayer service 616 and cloud anchors 618 are in the World Coordinate Space 604. Building information modeling (BIM) files 620 (site art or digital models) are in the UTM coordinate space 606. Spatial Data Service 622, GPS PaaS 624, and POIs 626 are in the WGS84 coordinate space 608.

FIG. 6 also illustrates one embodiment of the resolution process. When started the origin of the AR camera coordinate space 602 is set where the AR camera 610 is instantiated and is first able to resolve the ground plane 612. The origin is then associated with the Digital World Coordinate World 604 using the Visual Positioning System 120. Initially, GPS is used for low accuracy positioning. Then cloud anchors 618 are used for high accuracy.

This invention is unique because its relational nature allows a far greater amount of flexibility and mutability that would not apply to existing geographic information system (GIS) applications. While GIS systems extract given data from a particular GPS coordinate space, POI system 200 allows data to be written to coordinate systems that may vary across a schedule or periodicity. In addition, because the data is referential, or linked, it may be modified outside and independent of the stored reference.

An example embodiment of the POI system’s Content Management System (CMS) hosting architecture 140 is described. POI system 200 provides a POI authoring client 116 that interfaces with a spatial data service 310 and POI controller 406 and POI database 162 and cloud storage repository 176 and 412. POI authoring client 116 enables authors to define POIs and associate digital objects with specific coordinates, either in a physical coordinate system, such as UTM Coordinate Space 606 and WGS84 coordinate system 608 with latitude and longitude (FIG. 6), or a virtual coordinate system, such as Digital World Coordinate Space 604.

Because POI system 200 is cloud hosted, any Internet connected client applications can interface directly with the POI services comprising user interface 160 for users and/or POI authoring client 116 for authors. In an example embodiment, POI authoring client 116 and user interface 160 interface with the POI micro-services, spatial data service 310 and POI controller 406, through proxies AWS WAF 242 (FIG. 3) and resolvers (Route 53) 240 (FIG. 3) and load balancers (ALB) 244 (FIG. 3) using a set of REST interfaces, spatial data service 310 and POI controller 406. The micro-services, spatial data service 310 and POI controller 406, then interface with database 246 and data storage components 228 for record management and data references. In an example embodiment, database 246 is MongoDB Atlas database. POI system 200 is integrated with user services 302, User auth 102, and User database 122 for user account management.

Users can input data manually via POI authoring client 116 or rely on a data processing stream connected directly into the spatial data service 310 and POI controller 406. The entities that comprise these points of interest can be anything that can have an associated reference, whether an actual physical object, such as a trashcan, building, or mountain, or a virtual item, such as a character, location-based activity, or an event trigger. A physical location or standard time scale is not required to relate the objects. One can place objects in an imaginary space and time with their own unique systems as long as the consumer of the data understands how to interpret the referenced data source. Spatial data service 310 and POI controller 406 provides functionality to define and provide hints as to how the data should be consumed.

Metadata 218 is returned by the spatial data service 310 after the client application shares its physical location 230 and that location is matched to a POI entry in POI database component 162. This is pretty well diagrammed in FIG. 2. In most cases, the system outputs, metadata 218, are consumed by authors through POI authoring client 116 or by the users actually viewing the objects in a given location, but there are cases where entities are consumed in a programmatic fashion. For example, assume an entity has a defined geofence associated with it and a rule that makes the entity visible to the user when the user enters the geofence. The entity would only become visible to the user if they happened to enter the area defined by the geofence. Once the user had consumed, or viewed, the object, the system could store that information and maintain a record of it.

In an example embodiment, on-site physical users can view and interact with a digital layer matched to the physical world through AR. They can have context from positioning and awareness of the content available around them even through traditional interfaces. They have the ability to “replay” their experience, including content they did not engage with, but were proximate to.

Off-site digital users can view and interact with the same digital content over the digital twin such as through desktops, mobile devices, or VR. Off-site digital users can experience superpowers, such as flight. They can access video streams, including experiencing a 360° view, of the physical site to get a more realistic view.

All users can view and interact with other users and content, regardless of platform, to the best of their device and network capabilities.

Numerous applications exist for connected spaces and Platform 100 and method for creating them. For example, Platform 100 allows companies to create, update, and manage a virtual online presence their consumers can engage in. Physical spaces can be connected with other physical spaces. Platform 100 can connect physical spaces, such as malls, office buildings, entertainment centers, and museums that are full of digital content and smart devices, allowing management of the digital layer for the physical spaces.

Users can collaborate across the lifecycle of a space. Unlike simple videoconferencing, Platform 100 puts everyone in the same room, regardless of the device, and gives them the ability to work together in real time.

Connected spaces can be used for smart buildings and cities. Buildings and public infrastructure are becoming more data rich. Platform 100 offers the ability to make use of that information by empowering the physical and virtual occupants during design, construction and beyond.

For media and entertainment, connected spaces can create immersive experiences. They can create better films and television programs by building worlds and capturing the story with traditional interfaces. They allow exploring ideas faster with fewer people to ensure presentation of the best creative result on opening weekend, before creation of video effects (VFX). Connected spaces make movies agile. Platform 100 provides the ability to see the project early and often when changes are easy and inexpensive. It can provide clarity on costs and outcomes before tough decisions have to be made, and it takes the risks out of the unknown.

Platform 100 allows connecting with the audience in new ways, such as making the brand’s content personal, interactive, and engaging by giving the audience a role to play in the next generation of media and taking stories beyond theaters and screens, while benefiting the creation of that media on the way.

Platform 100 can simplify the complexity. As media becomes more digital, the complexity immobilizes everyone and sacrifices creativity and quality as costs run up. Platform 100 overcomes this by putting people around the globe, 24 hours a day, 7 days a week (24/7), on the same page and looking at the same movie.

For live events, conferences, and location-based entertainment venues, the user experience can be customized with dynamic content that designers can refresh and update as needed.

Designing and planning can be done in context. Designers and planners can create narratives, trigger events, and manage entertainment plans across the site. They can explore ideas freely as a team while early in production so they can build and present the best experience on opening day.

Event-management mission control is possible by allowing visualization of connected systems. The APIs of existing systems can be connected for monitoring guest activity and operations in context. The large amount of information can be made actionable.

Connected spaces will allow for better connections with the audiences by making the guest experience personal and engaging by using guest analytics in real-time. It can provide a digital layer for the guests to engage with on their personal devices and make the event respond better to their interests.

Connected spaces allow one or more people to share their experiences with the world. By consolidating digital content in a format that supports next-gen viewing devices, off-site engagement can be taken to new levels, drive more traffic to a physical location, and monetize it.

For retail centers, museums, and public spaces, users want and expect a digital layer. Platform 100 connects occupants of spaces to the opportunities around them in ways that give the operators visibility and enables the spaces to be customized to the occupants. It is possible to create narratives, trigger events, manage entertainment plans across the site. A digital layer can be created for guests to engage with on their mobile phones and devices to optimize traffic and make the space respond better to their needs.

Retail infrastructure can be managed from the inside. By connecting APIs to existing systems, guest activity and operations can be monitored in context and information can be made actionable.

Retail tenants can be offered a platform to connect with guests in the space. Data is a new type of utility like water and power. By sharing valuable guest analytics with tenants, it will allow tenants to make the guest experience personal and engaging and to help tenants succeed.

As digital content is consolidated, digital content in a format that supports next-gen viewing devices, off-site engagement can be driven to new levels and more traffic can be driven to a physical retail location instead of online retail.

Future exhibits can be designed from within for museums and science centers. Platform 100 makes it possible for all teams to work on the same page and to try out ideas before opening day. When the exhibits are launched, they will engage a younger audience with interactivity in the way they are used to interacting with data.

Visitor experiences at museums or science centers can be better understood and managed. Platform 100 can monitor what is popular and what is not. Then attention can be directed where it is needed, pinch points identified, and flow can be adjusted in real time to accommodate linger areas.

Existing museum and science center exhibits can be captured and made accessible to remote visitors around the world. Platform 100 makes it possible to preserve exhibits, localize them, and share them with a global audience without the costs of them traveling while controlling access and monetizing them.

Connected spaces can solve the problem of limited space for a museum or science center because immersive content has no walls and can grow to suit content needs. The experience for physical visitors on the site can be as personal as for remote visitors.

A common operational picture can exist for government spaces and use cases. Systems can be integrated via APIs to create a common interface that is accessible across platforms and teams. Physical assets and sites can be connected through digital twins so everyone is cognitively aligned in real-time.

Platform 100 and connected spaces can provide an environment for master planning and training for government spaces by using digital twins and multi-user collaboration to develop, test, and train assets through scenarios before taking them to the real world. Immersive training for the team is significantly more effective at preparing them for the real world.

Platform 100 and connected spaces can provide situational awareness related to government spaces. Platform 100 makes it possible for all teams to see the same information and collaborate with context. The team becomes far greater than the sum of the individuals when the world is an information-rich environment that is easily accessible and digestible.

Platform 100 and connected spaces can provide command and control of government spaces. They allow monitoring real-time events, coordinating assets on the ground, and running simulations in real-time in a simple contextual interface that resembles reality. Information and capabilities can be moved up and down the chain of command with levels of detail that match the context.

Platform 100 can work with smart cities. As urban infrastructure comes online and more connected spaces and buildings are built, the occupants expect an accessible layer of information in context for practical applications.

Platform 100 and connected spaces can be used for master planning for cities and buildings. They allow for live mission control overview of city events and monitoring data in context via APIs, instead of looking through different systems for pieces of information. Also, future and past events can be visualized in different layers to provide the overall context needed to enable city agents to arrive at the best decision.

Platform 100 and connected spaces can be used for civil and business operations for cities and buildings. For example, they can provide situational awareness for coordinated emergency response efforts, monitor data or devices in the environment in context for faster, better understanding, provide the ability to see teams on site and what critical information they’re streaming, and push content in context to the team’s mobile devices relevant to the things happening around them.

Platform 100 and connected spaces can also be used for resident and occupant services for cities and buildings by providing a better experience of what the city has to offer, providing way-finding and navigation, and providing access to richer content in context through mobile phones.

While the invention has been specifically described in connection with certain specific embodiments thereof, it is to be understood that this is by way of illustration and not of limitation. Reasonable variations and modifications are possible within the scope of the foregoing disclosure and drawings without departing from the spirit of the invention.

What is claimed is:

1. A points-of-interest system for a connected space comprising:
a controller;
a plurality of objects, each of the plurality of objects comprising a coordinate;
wherein the controller creates a record mapping the coordinate of each of the plurality
of objects to an object reference identifier for the object;
an object database for storing the object reference identifier for each of the plurality of objects;
a cloud storage; and
wherein the object database provides at least one object reference identifier to the cloud storage.

2. The points-of-interest system of claim 1 further comprising:
a position determining component for correlating a physical location of a first device with a digital location;
a digital location database;
wherein the digital location database looks up digital content for a physical location in the object database;
wherein the object database returns the digital content for the physical location to the first device;
wherein the digital location database looks up digital content for the digital location of a second device in the object database; and
wherein the object database returns the digital content for the digital location to the second device.

3. The points-of-interest system of claim 2 wherein the positioning determining component is a global positioning system (GPS).

4. The points-of-interest system of claim 2 wherein the positioning determining component is a compass.

5. The points-of-interest system of claim 2 wherein the first device is a smartphone.

6. The points-of-interest system of claim 2 wherein the first device is a tablet.

7. The points-of-interest system of claim 2 wherein the second device is a smartphone.

8. The points-of-interest system of claim 2 wherein the second device is a tablet.

9. The points-of-interest system of claim 2 wherein the plurality of objects comprises at least one physical object.

10. The points-of-interest system of claim 2 wherein the plurality of objects comprises at least one virtual object.

11. The points-of-interest system of claim 2 wherein the plurality of objects comprises:
at least one physical object; and
at least one virtual object.

12. The points-of-interest system of claim 2 wherein the object database stores metadata for each of the plurality of objects.

13. The points-of-interest system of claim 2 wherein the points-of-interest system is cloud hosted.

14. A points-of-interest system for a connected space comprising:
an authoring interface for creating and editing a plurality of points of interest within a coordinate space and a time by associating data with a set of coordinates and a time schedule; and
a service interface for logging and maintaining the relationships for the plurality of points of interest.

15. A points-of-interest system of claim 14 wherein the coordinate space is a physical coordinate space.

16. A points-of-interest system of claim 14 wherein the coordinate space is a virtual coordinate space.

17. A points-of-interest system of claim 14 wherein the coordinate space is a combined physical coordinate space and virtual coordinate space.

18. A method for creating and accessing points of interest in a connected space comprising:
storing an object reference identifier for each of a plurality of objects in an object database;
receiving coordinates for an object;
mapping the coordinates for the object to an object reference identifier for the object;
storing a record with the mapping of the coordinates for the object to the object reference identifier for the object in the object database.

19. The method of claim 18 further comprising:
providing a cloud storage;
receiving at least one locally referenced object at the cloud storage;
assigning the at least one locally referenced object an object reference identifier;
providing at least one object reference identifier for the at least one locally referenced object from the cloud storage to the object database.

20. The method of claim 19 further comprising:
receiving at least one object reference identifier for at least one remotely stored object from a remote cloud storage.

21. The method of claim 19 further comprising:
creating a connection between a physical object and a virtual object using a web-hosted, two-dimensional map interface.

22. The method of claim 19 further comprising:
creating the connection between the physical object and the virtual object using an immersive virtual reality interface.

23. A method for accessing points of interest in a connected space comprising:
receiving a physical location for a physical site in a physical coordinate space from a first device with a first camera at the physical location in the physical site in the physical coordinate space;
receiving a digital location in a coordinate space for a digital twin of the physical site from a second device;
providing a position determining component for correlating the physical location with the digital location;
providing a digital location database;
providing an object database with an object reference identifier for each of a plurality of objects associated with the physical site and for each of a plurality of objects associated the digital twin of the physical site;
correlating the physical location of the first device with the digital location using the position determining component;
looking up a digital content for the physical location in the object database;
returning the digital content at the physical location to the first device;
looking up digital content at the digital location of the second device in the object database; and
returning the digital content at the digital location to the second device.

24. A platform for a connected space comprising:
a point-of-interest system;
a massively multiplayer online (MMO) system;
a visual positioning system; and
a foundation.

25. A points-of-interest system for a connected space comprising:
a plurality of objects, each of the plurality of objects comprising:
a coordinate; and
a temporal information component, wherein the temporal information component indicates when the object is active;
a controller wherein the controller maps the coordinate of each of the plurality of objects to an object reference identifier;
an object database for storing the plurality of objects and the plurality of object reference identifiers; and
a cloud storage for providing at least one object reference identifier to the object database.

26. The points-of-interest system of claim 25 further comprising:
a position determining component for correlating a physical location of a first device with a digital location;
a digital location database;
wherein the digital location database looks up digital content for a physical location in the object database;
wherein the object database returns the digital content for the physical location to the first device;
wherein the digital location database looks up digital content for the digital location of a second device in the object database; and
wherein the object database returns the digital content for the digital location to the second device.

27. The points-of-interest system of claim 26 wherein the positioning determining component is a global positioning system (GPS).

28. The points-of-interest system of claim 26 wherein the positioning determining component is a compass.

29. The points-of-interest system of claim 26 wherein the first device is a smartphone.

30. The points-of-interest system of claim 26 wherein the first device is a tablet.

31. The points-of-interest system of claim 26 wherein the second device is a martphone.

32. The points-of-interest system of claim 26 wherein the second device is a tablet.

33. The points-of-interest system of claim 26 wherein the plurality of objects comprises at least one physical object.

34. The points-of-interest system of claim 26 wherein the plurality of objects comprises at least one virtual object.

35. The points-of-interest system of claim 26 wherein the plurality of objects comprises:
at least one physical object; and
at least one virtual object.

36. The points-of-interest system of claim 26 wherein the object database stores metadata for each of the plurality of objects.

37. The points-of-interest system of claim 26 wherein the points-of-interest system is cloud hosted.

38. A method for creating and accessing points of interest in a connected space comprising:
storing an object reference identifier for each of a plurality of objects in an object database wherein the object reference identifier comprises a temporal information component indicating when the object is active;
receiving coordinates for an object;
mapping the coordinates for the object to an object reference identifier for the object;
storing a record with the mapping of the coordinates for the object to the object
reference identifier for the object in the object database.

39. The method of claim 38 further comprising:
providing a cloud storage;
receiving at least one locally referenced object at the cloud storage;
assigning the at least one locally referenced object an object reference identifier;
providing at least one object reference identifier for the at least one locally referenced object from the cloud storage to the object database.

40. The method of claim 38 further comprising:
receiving at least one object reference identifier for at least one remotely stored object from a remote cloud storage.

41. The method of claim 38 further comprising:
creating a connection between a physical object and a virtual object using a web-hosted, two-dimensional map interface.

42. The method of claim 38 further comprising:
creating the connection between the physical object and the virtual object using an immersive virtual reality interface.

43. A platform for a connected space comprising:
a point-of-interest system comprising:
a plurality of objects wherein each of the plurality of objects comprises a temporal information component; and
wherein the point-of-interest system uses the temporal information component for each of the plurality of objects to determine when the objects are active;
a massively multiplayer online (MMO) system;
a visual positioning system; and
a foundation.

44. A points-of-interest system for a connected space comprising:
an object comprising:
a coordinate; and
a temporal information component, wherein the temporal information component indicates when the object is active;
a controller wherein the controller creates a record mapping the coordinate of the object to an object reference identifier for the object;
an object database for storing an object and the object reference identifier for the obj ect;
a cloud storage;
and wherein the object database provides at least one object reference identifier to the cloud storage.

45. The points-of-interest system of claim 44 further comprising:
a position determining component for correlating a physical location of a first device with a digital location;
a digital location database;
wherein the digital location database looks up digital content for a physical location in the object database;
wherein the object database returns the digital content for the physical location to the first device;
wherein the digital location database looks up digital content for the digital location of a second device in the object database; and
wherein the object database returns the digital content for the digital location to the second device.

46. The points-of-interest system of claim 45 wherein the positioning determining component is a global positioning system (GPS).

47. The points-of-interest system of claim 45 wherein the positioning determining component is a compass.

48. The points-of-interest system of claim 45 wherein the first device is a smarthone.

49. The points-of-interest system of claim 45 wherein the first device is a tablet.

50. The points-of-interest system of claim 45 wherein the second device is a smartphone.

51. The points-of-interest system of claim 45 wherein the second device is a tablet.

52. The points-of-interest system of claim 45 wherein the object is a physical object.

53. The points-of-interest system of claim 45 wherein the object is a virtual object.

54. The points-of-interest system of claim 45 wherein the object database stores metadata for object.

55. The points-of-interest system of claim 45 wherein the points-of-interest system is cloud hosted.
